(19) United States
(12) Patent Application Publication
(10) Pub. No.: US 2016/0318336 A1
(43) Pub. Date: Nov. 3, 2016

(54) Game Rimz

(71) Applicant: Angela Dianne Patterson, Columbus, GA (US)

(72) Inventor: Angela Dianne Patterson, Columbus, GA (US)

(21) Appl. No.: 14/150,923

(22) Filed: Jan. 9, 2014

(51) Int. Cl. B60B 7/00; B60B 7/08; B60B 7/06; B60B 7/04

(52) U.S. Cl. CPC B60B 7/0053; B60B 7/04; B60B 7/08; B60B 7/063; B60B 2360/00; B60B 2900/572; B60B 2360/32; B60B 2900/111; B60B 2900/3318; B60B 2900/551; B60B 2900/112; B60B 2900/531

(57) ABSTRACT

A decorative wheel cover comprising a decorative sign, a disc frame, and retractable claw arm assemblies with claws attachable to automobile wheels between the rim and tire by a person manually without using any tools.

### CROSS REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A SEQUENCE LISTING

Not Applicable

### BACKGROUND OF THE INVENTION

1. Field of the Invention

This invention relates generally to decorative wheel covers, and more particularly it pertains to after market decorative automobile center wheel covers displaying iconic symbols.

2. Description of Related Art

In the business of decorative wheel covers, the provision of center wheel covers or hub cap, has been a particular problem. A fair amount of expense is required in providing such wheel covers. Generally prior art wheel covers (hub caps) are formed separately from the wheel itself. A name, company escutcheon, or logo is often provided on the hub cap, which is made separate and removable from the wheel to allow access to the wheel center for changing tires. Many different methods and types of apparatuses are utilized in the prior art for fixing such decorative wheel covers or hub caps to automobile wheels. For example, on many automobiles a metal plate is provided on the back side of the wheel which is joined by screws, locating pins, and the like, in tapped holes and guide holes in the wheel center. Other prior methods include the use of springs, many sorts of clips, slots, cams, to fasten wheel decorative wheel covers to automobile wheels.

The present invention overcomes these problems by achieving the following objectives: providing a decorative wheel cover, which is light weight, theft-proof, resistant to being loosened by road shock and vibration, inexpensive, adorning, and yet easy to install without the use of tools. The various forms of the present invention meets all of these objectives, and provides generally improved decorative wheel covers over the prior art.

### BRIEF SUMMARY OF THE INVENTION

The present invention is directed toward systems and methods to achieve the objectives above. The present invention comprises a decorative wheel cover that can be mounted and dismounted without tools on the wheel rim of any conventional automobile wheel between the tire and rim. The wheel cover comprising a circular decorative disc sign and a circular disc frame, including a plurality of radially retractable claw arm assemblies, circumferentially spaced apart including two opposing ends. The First end of each claw arm assembly points towards the circular disc frame center. The second end of each claw arm assembly includes claws which clamp to the circumferential edge of the wheel rim between the tire and rim. The claw arm assemblies are retractable such that the claws can clamp to any size conventional consumer automobile wheel. The claws are adapted to wedge between the circumferential rim edge and the tire. Once the claws are clamped to the rim, the claw arm assemblies may be manually retracted, wherein the claw arm assembly first ends are radially biased toward the disc frame center, such that the claws form a grip tight enough so that the wheel cover does not dismount during on-road driving conditions. The disc frame and claw arm assemblies are made of durable material, strong enough to absorb vibrations of on-road conditions. The geometry of the disc frame and claw arm assemblies are adapted to absorb on-road vibrations as well.

Other objects and advantages of the present invention will be readily apparent upon a reading of the following brief descriptions of the drawing figures, detailed descriptions of preferred embodiments of the invention, the appended claims and drawings.

### BRIEF DESCRIPTION OF THE SEVERAL VIEWS OF THE DRAWINGS

The above mentioned and other objects and features of this invention and the manner of attaining them will become apparent, and the invention itself will be best understood by reference to the appended drawings. In the course of the following detailed description, reference will be made to the appended drawings in which:

FIG. 1A: A 3-D perspective of the Game Rimz Wheel Cover mounted to an automobile rim.

FIG. 1B: A 3-D perspective of the Game Rimz Wheel Cover mounted to an automobile rim larger than the rim if FIG. 1A.

FIG. 2: Front, Side, and a 3-D perspective of the Game Rimz Wheel Cover

FIG. 3: An exploded components view of the Game Rimz Wheel Cover including a conventional automobile rim

FIG. 4: 3-D perspectives of the disc frame of the Game Rimz Wheel Cover, illustrating the retractability of the Claw Arm Assemblies

FIG. 5: A 3-D perspective of the Disc Frame Assembly and exploded views of the Claw Arm Assembly of the Game Rimz Wheel Cover

FIG. 6A: A 3-D perspective of the Game Rimz Wheel Cover Disc Frame mounted with a Decorative Sign

FIG. 6B: A 3-D perspective of the Game Rimz Wheel Cover Disc Frame

FIG. 7: An exploded components view of the Claw Arm Assembly

### DETAILED DESCRIPTION OF THE INVENTION

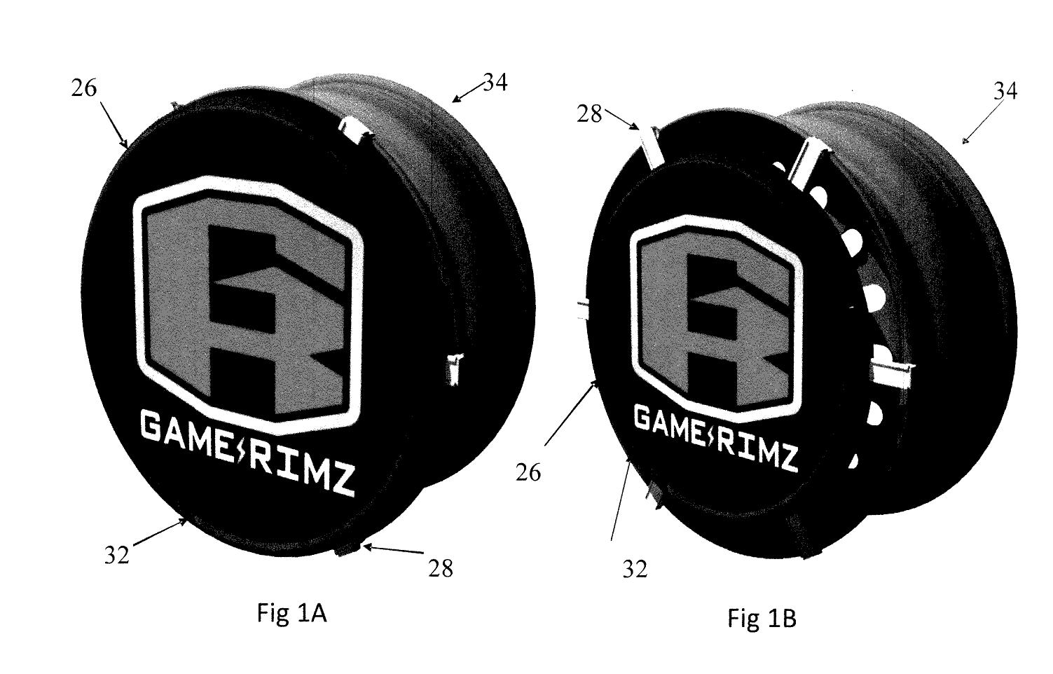

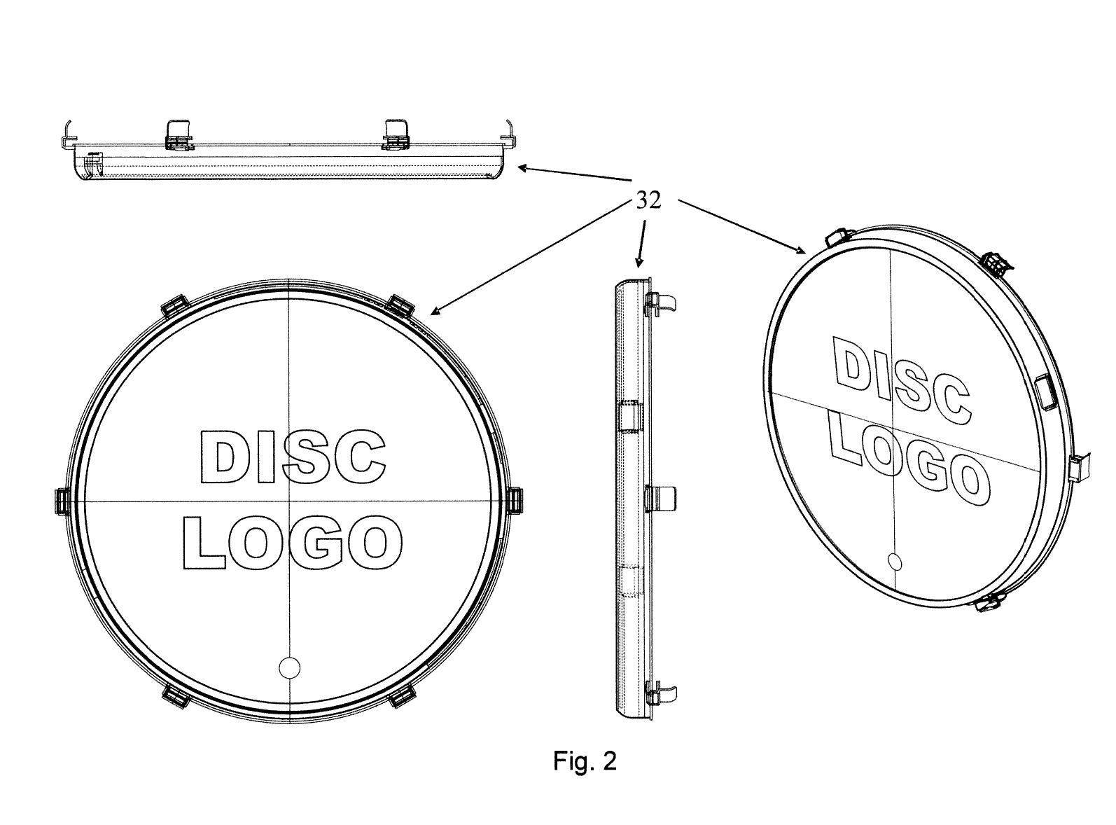

In the following description, like reference characters designate like or corresponding parts throughout the several views. Referring now to the drawings in detail, reference is made to FIGS. 1A, 1B, 2, and 3. The present invention is directed toward a decorative wheel cover (32) comprising: a circular decorative disc sign (26) and a plurality of claw arm assemblies (38). The disc frame (21) has a substantially flat side, an opposing inside, and a circumferential edge. The decorative disc sign (26) is detacheably attached to the flat side of the disc frame (21).

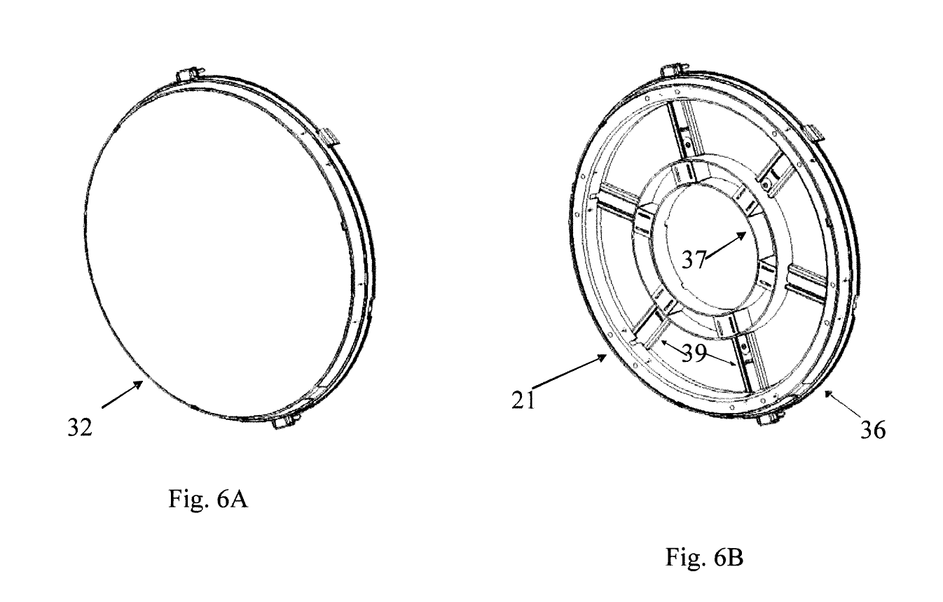

Referring to FIG. 6B, the disc frame (21) further comprises an inner ring portion (37) and an outer ring portion (36) and a plurality of elongated substantially straight portions (39). The disc frame straight portions (39) are connected to the inner ring portion (37) and outer ring portion (36), wherein the disc frame straight portions (39) are circumferentially spaced apart about the disc frame center.

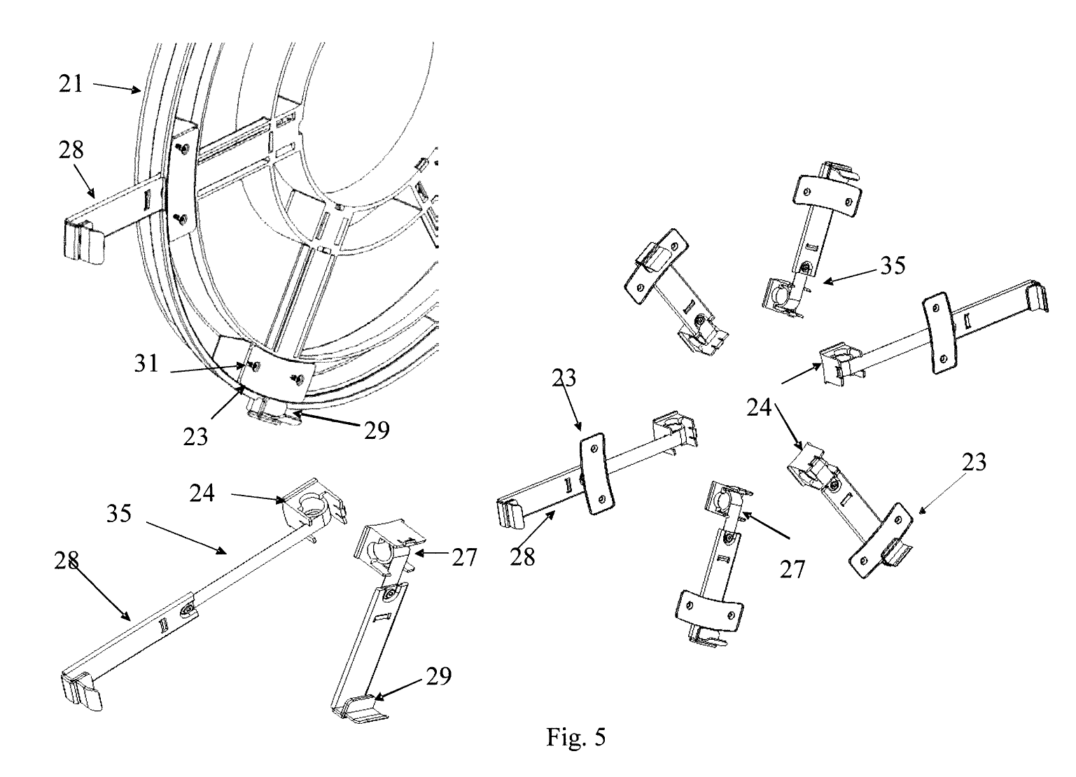

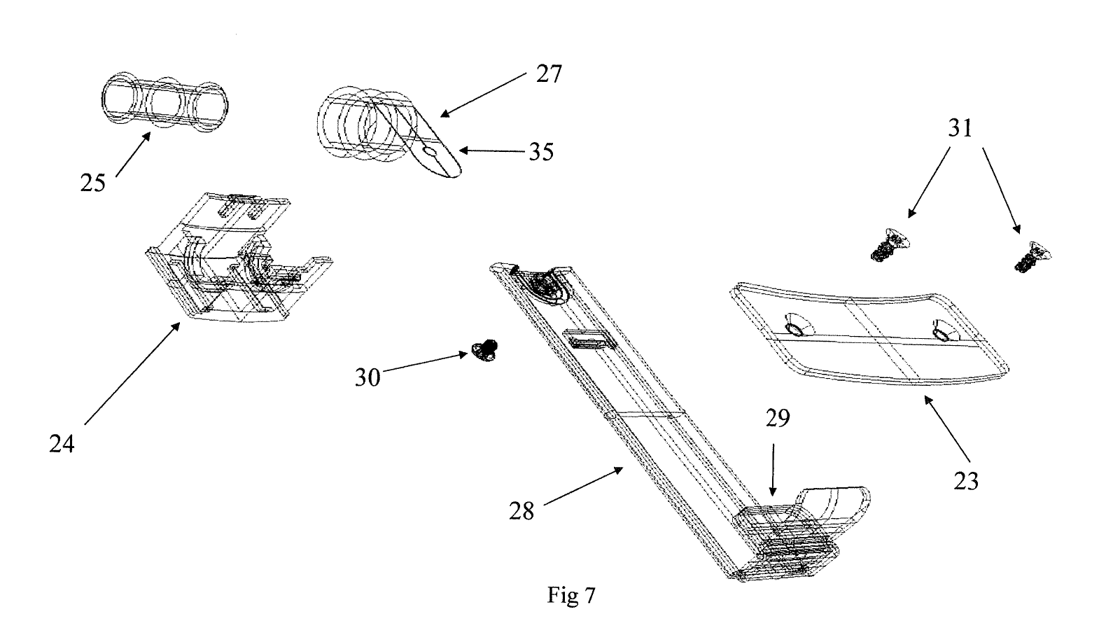

Referring to FIGS. 5 and 7, each claw arm (28) comprises a first end and an opposing claw end with a straight elongated portion there between. Each claw arm straight portion has an interior side and an outer side. The outer sides of the claw arm straight portions are configured to mate with the disc frame straight portions, wherein each claw arm straight portion is radially, slidably, and detachably attached to a separate disc frame straight portion (39); wherein the claw end of each claw arm (28) extends radially beyond the circumferential edge of the disc frame outer ring (36), and the first end of each claw arm (28) radially retracts toward the center of the disc frame (21). The claw arms (28) are extensible, such that the claw end of each claw arm (28) can be securely attached to any size rim of an automobile wheel between the circumferential edge of the wheel rim (34) and tire (as in FIG. 1A and 1B; tire not shown).

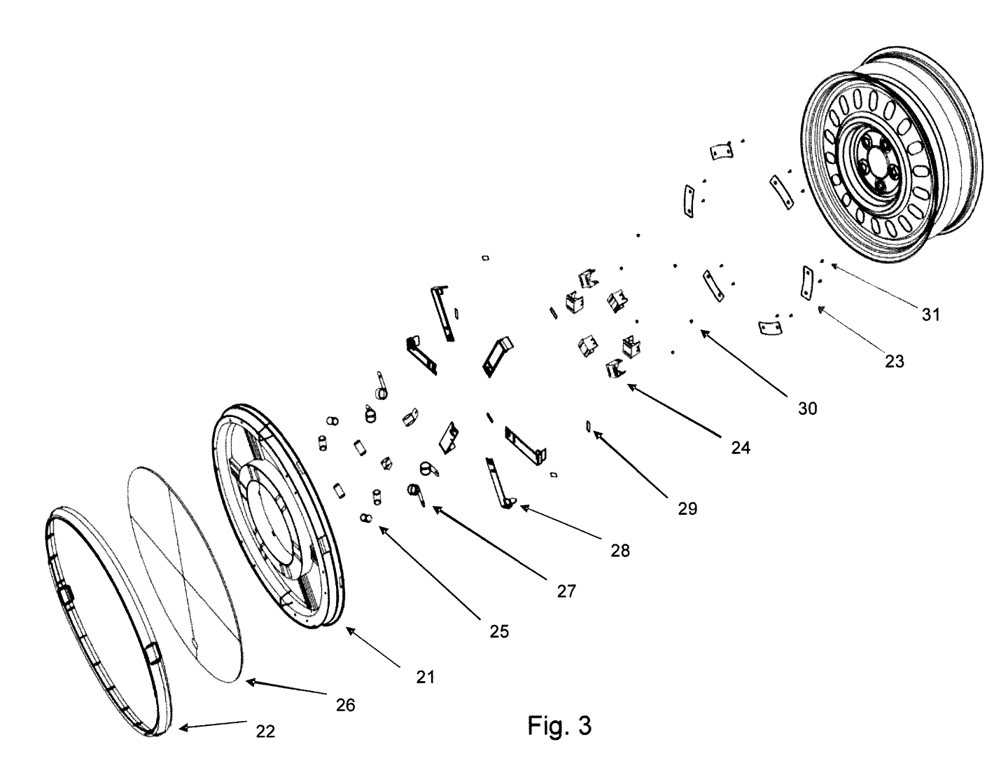

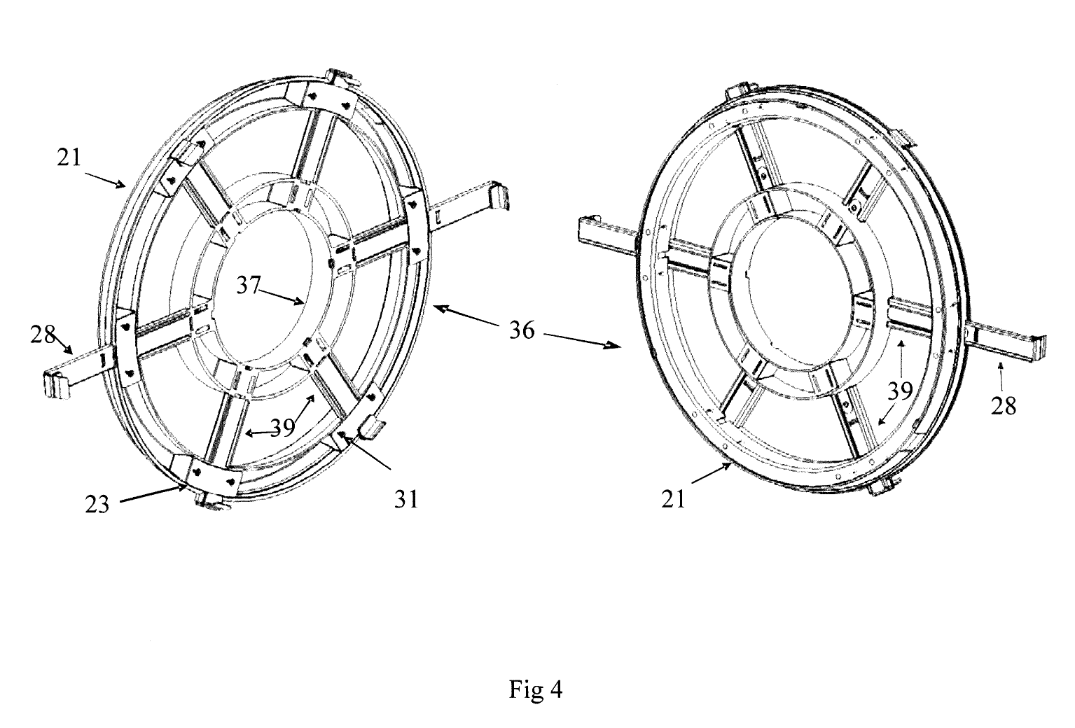

Referring to FIG. 3, a preferred embodiment of the present invention comprises a trim ring (22), wherein the decorative disc sign (26) is held in place by the trim ring (22) which is sized to fit securely around and over the circumferential edge of the disc frame (21). The disc frame straight portions (39) are rigidly connected to the disc frame inner ring (36) and disc frame outer ring (37) portions, and are symmetrically and circumferentially spaced apart about the disc frame center.

Referring to FIGS. 5 and 7, in a preferred embodiment each claw arm assembly (38) comprises a claw arm (28), a spring shaft (25), a continuous force coil spring (27), a claw pad (29), a spring cap (24), a spring claw screw (30), a claw support cover (23), and a pair of torx screws (31). The first end of each claw arm (28) has a slot. Each continuous force coil spring (27) has a flattened end (35). Each spring shaft (25) is inserted inside a separate continuous force coil spring (27). Each continuous force coil spring (27) is attached to the disc frame inner ring portion (36) adjacent to a separate disc frame straight portion (39), wherein a separate claw arm first end is inserted with the continuous force coil spring flattened end (35), a separate spring cap (24) holds together the continuous force coil spring (27) and the spring shaft (25) to the disc frame inner ring portion (36); a separate spring claw screw (30) is inserted between the continuous force coil spring flattened end (35) and the claw arm first end, holding them together. A separate claw support cover (23) and a pair of torx screws (31) hold together the claw arm (28) and disc frame straight portion (39), but allowing the claw arm (28) to radially slide along the disc frame straight portion (39).

Still referring to FIGS. 5 and 7, in another preferred embodiment, the disc frame straight portions (38) have cavities; the interior sides of the claw arm straight portions have inner groves; the outer sides of the claw arm straight portions are configured to mate with the cavities of the disc frame straight portions.

Referring to FIGS. 1A and 1B, FIG. 5, and FIG. 7, each continuous force coil spring (27) is biased toward the disc frame center; wherein, when a spring claw screw (30) holds together a claw arm first end and a continuous force coil spring flattened end (35), the claw arm first end is radially pulled toward the disc frame center, the claw arm (28) slides along the disc frame straight portion (39) and the claw arm (28) claw end pulls toward the disc center; wherein, in order to clamp the claw arm claw end between a wheel rim (34) and tire, a person manually pulls the claw arm claw end, sliding the claw arm (28) along the disc frame straight portion (39) away from the disc frame center; wherein the force coil spring (27) providing resistance in the claw arm claw end, which forms a tight grip between the wheel rim (34) and tire.

Another preferred embodiment comprises a plurality of electric motors and a wireless remote control (not shown). Each motor includes a wireless controller. Each spring shaft (25) is inserted with a separate motor. The wireless remote control operates the motors in synchronization. The motors are sized to further bias the continuous force coil springs (27) to pull each continuous force coil spring flattened end (35) toward the disc center, in turn pulling each claw arm (28) toward the disc center, in turn creating enough resistance in the claw arm claw ends, so that when a person activates the remote control, doing so causes the continuous force coil spring (28) to pull the claw arms (28) toward the disc frame center, causing the claw arm claw ends to clamp down on the wheel rim circumferential edge; wherein, the decorative wheel cover (32) is more tightly secured to the wheel rim (34), enabling the wheel cover to remain attached to the rim during on-road use.

In another embodiment, the geometry and material of the disc frame are designed to absorb vibrations of on-road use. In this case, the disc frame straight portions (39) are designed slender, and the material of the disc frame straight portions (39) are durable but pliable, so that the disc frame straight portions transfers the vibrations to the disc frame inner ring (37), such that the disc frame inner ring vibrates, but the claw ends remain attached to the wheel rim circumferential edge.

In a preferred embodiment, the disc frame straight portions (39) are made of durable and flexible thermoplastic. In another embodiment, the disc frame (21) is made of durable brittle plastic that will shatter into small pieces upon sharp impact, such as when a wheel rim hits a pothole. The shattered small pieces eliminate the possibility of a dislodged wheel cover becoming airborne upon impact with a pothole causing a car accident. Thermoplastic is inexpensive, and the manufacturing techniques, commonly known in the art, to manufacture the wheel cover (32) are inexpensive.

In another preferred embodiment designed for wheels with a plurality of spokes circumferentially spaced apart about the center of the wheel rim (not shown), the disc sign (26) is made of durable textile fabric; the disc sign (26) includes a plurality of straps; each strap has fasteners; the straps are circumferentially spaced apart about and adjacent to the circumferential edge of the disc sign, such that the disc sign is mountable directly onto a wheel rim (34); wherein each strap can be wrapped around a separate wheel spoke, and fastened, such that the disc sign does not dislodge from the wheel rim during on-road use.

All of the above descriptions are merely illustrative of the many applications of the present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention is not to be limited to the details given herein, but may be modified within the scope of the appended claims.

What is claimed is:

1. A decorative wheel cover comprising: a circular decorative disc sign; and a circular disc frame, including a plurality of radially retractable claw arm assemblies, circumferentially spaced apart;
the disc frame has a substantially flat side, an opposing inside, and a circumferential edge; the decorative disc sign is detacheably attached to the flat side of the disc frame;
the disc frame further comprises inner and outer ring portions and elongated substantially straight portions; the disc frame straight portions are connected to the inner and outer disc frame ring portions, circumferentially spaced apart about the disc frame center;
each claw arm assembly comprises a first end and an opposing claw end with a straight elongated portion there between; each claw clamps to the circumferential edge of a wheel rim between the tire and rim; each claw arm straight portion has an interior side and an outer side; the outer sides of the claw arm straight portions are configured to mate with the disc frame straight portions, wherein each claw arm straight portion is radially, slidably, and detachably attached to a separate disc frame straight portion; wherein the claw end of each claw arm assembly extends radially beyond the circumferential edge of the disc frame, and the first end of each claw arm assembly radially retracts toward the center of the disc frame;
the claw arm assemblies are extensible, such that the claw end of each claw arm assembly can be securely attached to any size rim of a consumer automobile wheel between the circumferential edge of the rim and tire.

2. The apparatus in claim 1, wherein the claws are adapted to wedge between the circumferential rim edge and the tire, and the claw arm assembly first ends are radially biased toward the disc frame center; such that, once the claws are clamped to the rim, the claws form a grip tight enough so that the wheel cover does not dismount during on-road driving conditions.

3. The apparatus in claim 2, wherein the disc frame and claw arm assemblies are made of durable material, strong enough to absorb vibrations of on-road conditions; and the geometry of the disc frame and claw arm assemblies are adapted to absorb on-road vibrations as well.

4. The apparatus in claim 1, comprising: a trim ring, wherein the decorative disc is held in place by the trim ring which is sized to fit securely around and over the circumferential edge of the disc frame.

5. The apparatus in claim 4, wherein the disc frame straight portions are rigidly connected to the inner and outer disc frame ring portions, and are symmetrically and circumferentially paced apart about the disc frame center.

6. The apparatus in claim 5, wherein each claw arm assembly comprises a claw arm, a spring shaft, a continuous force coil spring, a claw pad, a spring cap, a spring claw screw, a claw support cover, and a pair of torx screws;
the first end of each claw arm has a slot; each continuous force coil spring has a flattened end; each spring shaft is inserted inside a separate force coil spring, each force coil spring is attached to the inner disc frame ring portion adjacent to a separate disc frame straight portion, wherein each claw arm slotted end is inserted with the force coil spring flattened end, a separate spring cap holds together the force coil spring and the spring shaft to the disc frame ring portion; a separate spring claw screw is inserted between the force coil spring flattened end and the claw arm slotted end, holding them together;
a separate claw support cover and a pair of torx screws hold together a separate claw arm and disc frame straight portion, but allowing the claw arm to extend and retract radially along the disc frame straight portion.

7. The apparatus in claim 6, wherein the disc frame straight portions have cavities; the interior sides of the claw arm straight portions have inner groves; the outer sides of the claw arm straight portions are configured to mate with the cavities of the disc frame straight portions.

8. A decorative wheel cover removably mountable to a wheel of a consumer automobile, comprising: a circular decorative disc sign, and trim ring, a circular disc frame, and a plurality of claw arm assemblies;
the disc frame has a substantially flat side, an opposing inside, and a circumferential edge; the decorative disc is detacheably attached to the flat side of the disc frame, held in place by the trim ring which is sized to fit securely around and over the circumferential edge of the disc frame;
the disc frame further comprises inner and outer ring portions and elongated substantially straight portions with cavities therein; the disc frame straight portions are rigidly connected to the inner and outer disc frame ring portions, symmetrically and circumferentially spaced apart about the disc frame center;
each claw arm assembly comprises a claw arm, a spring shaft, a continuous force coil spring, a claw pad, a spring cap, a claw screw, a claw support cover, and a pair of torx screws;
each claw arm assembly comprises a slotted end and an opposing claw end with a straight elongated portion there between; each claw arm straight portion has an interior side and an outer side, the interior sides having inner groves; the outer sides of the claw arm straight portions are configured to mate with the cavities of the disc frame straight portions, wherein each claw arm straight portion is radially, slidably, and detachably attached within the cavity of a separate disc frame straight portion;
wherein the claw end of each claw arm extends radially beyond the circumferential edge of the disc frame, and the slotted end of each claw arm radially retracts toward the center of the disc frame;
the spring shaft, the continuous force coil spring, the claw pad, the spring cap, the claw screw, the claw support cover, and the torx screws are connected to the claw arm and disc frame such that each claw arm remains securely attached to the disc frame and the claw arm is capable of being manually extended by a person, such that the claw end of each claw arm can be securely attached to any size rim of a conventional consumer automobile wheel between the circumferential edge of the rim and tire.

9. The apparatus in claim 8, wherein each continuous force coil spring is biased toward the disc frame center; wherein, when a spring claw screw holds together a claw arm first end and a continuous force coil spring flattened end, the claw arm first end is radially pulled toward the disc frame center, the claw arm slides along the disc frame straight portion and the claw arm (28) claw end pulls toward the disc center; wherein, in order to clamp the claw arm claw end between a wheel rim and tire, a person manually pulls the claw arm claw end, sliding the claw arm along the disc frame straight portion away from the disc frame center; wherein the force coil spring providing resistance in the claw arm claw end, which forms a tight grip between the wheel rim and tire.

10. The apparatus in claim 9, comprising a plurality of electric motors and a wireless remote control; wherein each motor includes a wireless controller; each spring shaft is inserted with a separate motor; the wireless remote control operates the motors in synchronization; the motors are sized to further bias the continuous force coil springs to pull each continuous force coil spring flattened end toward the disc center, in turn pulling each claw arm toward the disc center, in turn creating enough resistance in the claw arm claw ends, so that when a person activates the remote control, doing so causes the continuous force coil spring to pull the claw arms toward the disc frame center, causing the claw arm claw ends to clamp down on the wheel rim circumferential edge; wherein, the decorative wheel cover is more tightly secured to the wheel rim, enabling the wheel cover to remain attached to the rim during on-road use.

11. The apparatus in claim 10, wherein the geometry and material of the disc frame are designed to absorb vibrations of on-road use; wherein, the disc frame straight portions are designed slender, and the material of the disc frame straight portions are durable but pliable, so that the disc frame straight portions transfer the vibrations to the disc frame inner ring, such that the disc frame inner ring vibrates, but the claw ends remain attached to the wheel rim circumferential edge.

12. The apparatus in claim 11, wherein, the disc frame straight portions are made of durable and flexible thermoplastic.

13. The apparatus in claim 11, wherein, the disc frame is made of durable brittle plastic that will shatter into small pieces upon sharp impact, such as when a wheel rim hits a pothole; wherein the shattered small pieces eliminate the possibility of a dislodged wheel cover becoming airborne upon impact with a pothole causing a car accident.

14. A decorative wheel cover designed for wheels with a plurality of spokes circumferentially spaced apart about the center of the wheel, the wheel cover comprising: a disc sign with a circumferential edge, and a plurality of straps; the disc sign is made of durable textile fabric; each strap has fasteners; the straps are circumferentially spaced apart about and adjacent to the circumferential edge of the disc sign; the disc sign is mountable directly onto a wheel rim; wherein each strap can be wrapped around a separate wheel spoke, and fastened, such that the disc sign does not dislodge from the wheel rim during on-road use.
